(19) United States
(12) Patent Application Publication
(10) Pub. No.: US 2015/0056401 A1
(43) Pub. Date: Feb. 26, 2015

(54) FLOOR SURFACE PROTECTIVE SHEET

(71) Applicants: Nizzar FARAH, Nazareth (IL); Hussam FARAH, Nazareth (IL)

(72) Inventors: Nizzar Farah, Nazareth (IL); Hussam Farah, Nazareth (IL)

(21) Appl. No.: 14/388,871

(22) PCT Filed: Mar. 4, 2013
(86) PCT No.: PCT/IL2013/050189

§ 371 Date: Sep. 29, 2014

(30) Foreign Application Priority Data
Apr. 3, 2012 (IL) 219008

(51) Int. Cl. E04G 21/24; E04G 23/02; E04F 15/00; B32B 37/12; B32B 37/22

(52) U.S. Cl. CPC E04G 21/24; B32B 37/1284; B32B 37/22; E04F 15/00; E04G 23/0288
USPC 428/78; 156/547; 52/506.05

(57) ABSTRACT

A floor surface (12) protective sheet (10A), comprising: an elongated flexible surface (20); and a plurality of rigid plates (18) attached to the elongated flexible surface (20), wherein the rigid plates (18) and the attachment thereof are characterized for avoiding deformation of the elongated flexible surface (20) upon weight of a person treading thereon, thereby avoiding deformation of the floor surface (12) on which the protective sheet (10) is laid, and allowing folding the protective sheet (10A).

### FIELD OF THE INVENTION

The present invention relates to protective sheets on built surfaces and a method for production thereof. More precisely, the present invention is designed generally for protection of tiled and/or covered and/or coated surfaces during construction.

### BACKGROUND

During construction there is a problem of damage caused to tiled, covered and/or coated surfaces as a result of mechanical breaks, staining of the floor with paint, plaster, building materials, etc. The reason for this is that after finishing the flooring, covering and/or coating works, it is still necessary to bring in craftsmen to work on these surfaces and this is liable to damage them (i.e. the coating/covering/flooring etc.).

Currently, the usual solution to this problem is covering these surfaces (namely coating/covering/flooring etc., that have reached their finished form) with protective surfaces made of corrugated cardboard, plaster plates, nylon, wood plates, etc.

However, each of these solutions has its own problems. Some of the problems of these materials are presented below:
1. The use of some of the materials generally employed for a protective surface is prohibited pursuant to the Israeli Standard in this matter. For instance, it is forbidden to use corrugated cardboard, according to Israeli Standard 1629.
2. Cardboard is also a very lightweight material, and therefore it is not stable. It is also not waterproof.
3. Covering with these materials is not reliable, and therefore it does not satisfactorily protect the flooring and the coated and covered surfaces during construction.
4. The cost of protective covering made of certain materials, for instance, plaster or wood, is very expensive, both as a result of the price of the actual material and because of the complicated removal at the end of the process. Consequently, many users are deterred from using a protective covering on the tiled or coated areas.
5. Most of the materials in use as protective covering are not impervious to water or liquids, and therefore they do not prevent seepage of liquids such as water, oil, paint etc., that damage the finished tiled and coated surfaces.
6. Some of the protective covering materials not impervious to water and liquids crumble and can damage the surfaces that they were designed to protect.
7. In fact, the protective covering materials are single-use, and this greatly increases their cost. This is a considerable expense for craftsmen who use protection routinely in their work.
8. The rigid protective materials, such as wooden plates, are liable to increase the problem; if foreign material, hard dirt (gravel, for instance) gets under the protective plate, the plate will become a factor that increases the prospect of damage to the finished floor or its coating when people tread on the plate, not precisely over the dirt, but also around it.
9. The transport of some of the protective materials is difficult, and they are not user-friendly; they are supplied in large sizes, are rigid, and cannot be folded.
   The object of the present invention is to provide a solution to the problems indicated above, and other problems of the prior art.

### SUMMARY OF THE INVENTION

The present invention relates to protective sheets on finished surfaces and a method for production thereof.

A protective sheet (10A) contains the following main elements:
1. Flexible base surface (20);
2. Two or more relatively rigid plates (18), connected to the base surface (20) parallel to each other, so that between every two rigid plates (18) there is a gap (23) that allows folding of the base surface (20);
3. Consequently, the protective sheet (10A) can be stored compactly until use.

The flexible base surface (20) can be made of polyethylene foam, nylon with air bubbles or any other spongy material. In fact, any flexible sheet that is not harmful can serve as base material for the protective sheet. The flexible base surface (20) can also be made of several layers (26), with each layer being made of a different material.

According to one of the preferred applications of the invention, the flexible base surface (20) is impervious to liquids, with the object of preventing liquids from seeping onto the protected surface.

The relatively rigid plates (18) are made of a rigid material so that the weight of a person treading on a protective plate (18) does not cause folding or deformation of the plate. For instance, the rigid plates (18) can be made of wood, plastic, cardboard, etc.

The rigid plates (18) can be connected to the base surface in various ways, such as adhesion, soldering, sewing, studs, hot welding, etc.

This structure allows a plurality of protective sheets (10A, 10B, 10C) one attached to the other. The storage of the protective sheet (10A) is compact, since it can be folded and/or rolled up.

The protective sheets (10A) can be produced in various sizes and from different materials, at the customer's request. At the time of use, it is also possible to shorten them by folding or cutting.

Connections of different types can be created between the different protective sheets (10A, 10B, 10C), for instance, overlapping, or sticking them together with tape or other adhesive material, and they can be connected with hot welding. The gaps (23) between the rigid plates (18) can be tailored as required.

Due to the softness of the protective sheet's base surface (20), it absorbs part of any blow caused by a falling object.

Each of the protective sheets (10A) can be folded in the form of a roll or by folding, thus producing a compact structure that allows very easy transport or storage. The protective sheets can also be installed in modular form.

According to one of the preferred configurations of the invention, the base surface (20) is made of polyethylene foam, while the rigid plates (18) are made of Medium Density Fiberboard (MDF).

The protective sheets (10A) can be produced manually or by an automated machine (28) that will produce and/or connect between the flexible material of the base surface (20) and the rigid material of the rigid plates (18), and will fold or roll them.

### EXAMPLES OF PREFERRED APPLICATIONS OF THE INVENTION

The present invention will be described in detail in drawings 1 to 6. These drawings are intended for illustration of several preferred configurations of the present invention, without any intention of reducing the scope of its configurations.

### BRIEF DESCRIPTION OF THE DRAWINGS

FIG. 1 is a perspective schema showing the way in which tiles are conventionally protected on a building site, according to the prior art.

FIG. 2 is a perspective schema depicting the protective sheets for protecting the floor surface, according to a preferred application of the present invention.

FIG. 3 depicts a single protective sheet of FIG. 2.

FIG. 4 shows in perspective the protective sheet of FIG. 3 in a folded state.

FIG. 5 shows a cross-section of the protective sheet of FIG. 3.

FIG. 6 is a side view showing a machine for producing the protective sheet of FIG. 3, according to one embodiment.

### DETAILED DESCRIPTIONS OF THE INVENTION

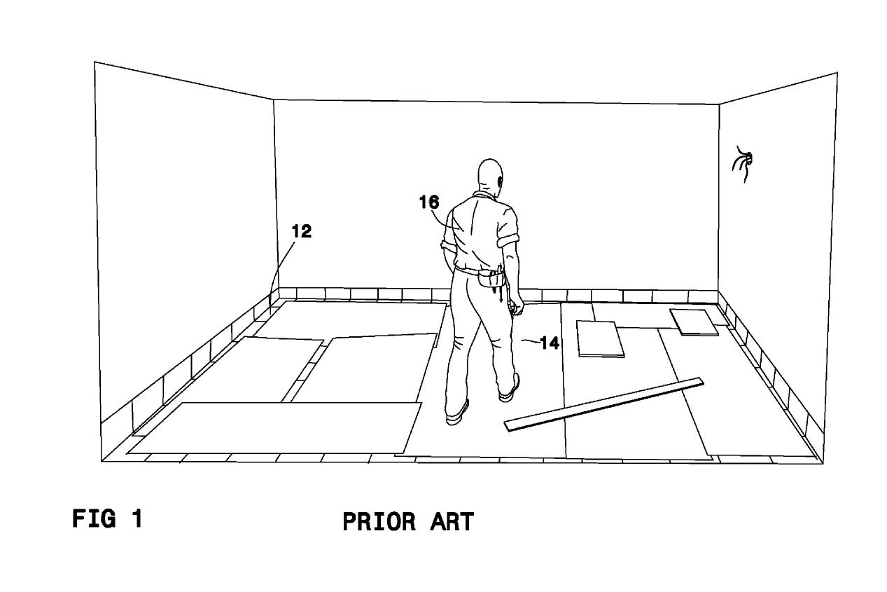

FIG. 1 is a perspective schema showing the way in which tiles are conventionally protected on a building site, according to the prior art.

The conventional approach providing protection of tiles is laying cardboard, plaster plates, wooden plates (14), etc. on the floor surface (12).

The raw materials (14) serving for the protective covering of the tiles of the floor surface (12) are improvised. For instance, lightweight cardboard and sometimes heavy objects such as tiles, wooden plates, etc. must be placed on it to prevent it from lifting up or moving. This method does not completely seal the floor surface (12), and whenever a craftsman (16) works at the site, the covering (14) moves, and dirt (for instance, plaster, paint, etc.) can stain the tiles of the floor surface (12). It is also not safe to work on-site, since the craftsman (16) can stumble on wood or plates scattered on the flooring.

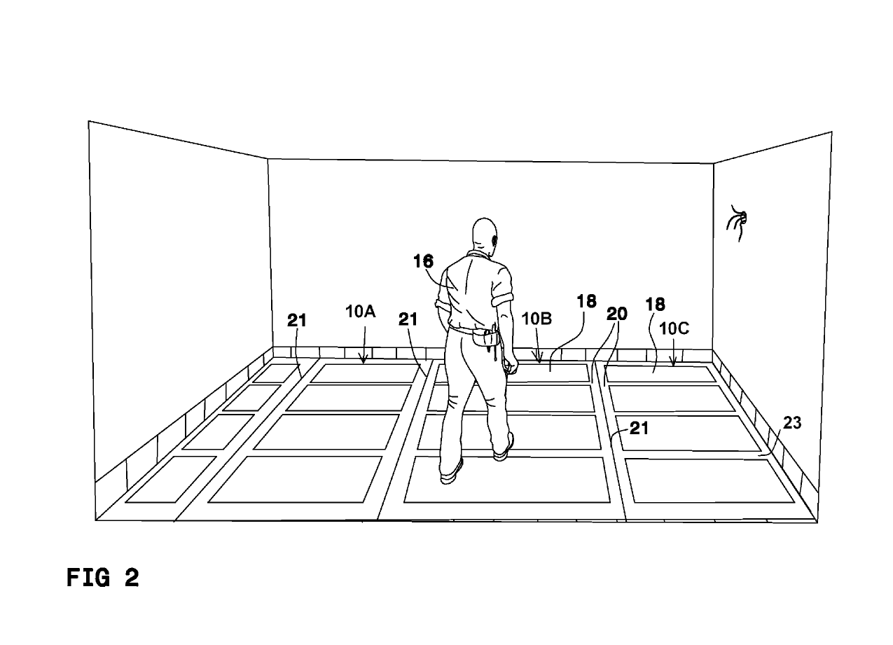

FIG. 2 is a perspective schema depicting the protective sheets for protecting the floor surface, according to a preferred application of the present invention.

The diagram shows a building site where the tiles of the floor surface (12) are protected by a plurality of protective sheets (10A, 10B, 10C) according to a preferred application of the present invention. Line (21) between the different protective sheets (10A, 10B, 10C) connects the sheets one to the other. Each protective sheet (10A) includes a base surface (20) made of flexible and impermeable material. A plurality of rigid plates (18) are adhered to each base surface (20). Relatively small gaps (23) between each two rigid plates (18), in relation to the size of the rigid plates (18), allow folding the base surface (20), such that the rigid plates (18) are disposed one on top of the other. The gap (23) between the rigid plates (18) allows folding each base surface (20) separately upon termination of use, for purposes of storage and reutilization.

The flexible base surface (20) is laid on the tiles of the floor surface (12) for protecting the tiles from scratches, stains of different building materials, damage in case of falling of heavy objects, etc. The rigid plates (18) which are made of rigid material press the flexible material (20) down on the tiles of the floor surface (12).

Rigid plates (18) are relatively thin, thus they do not include protrusions on which the craftsman (16) might stumble.

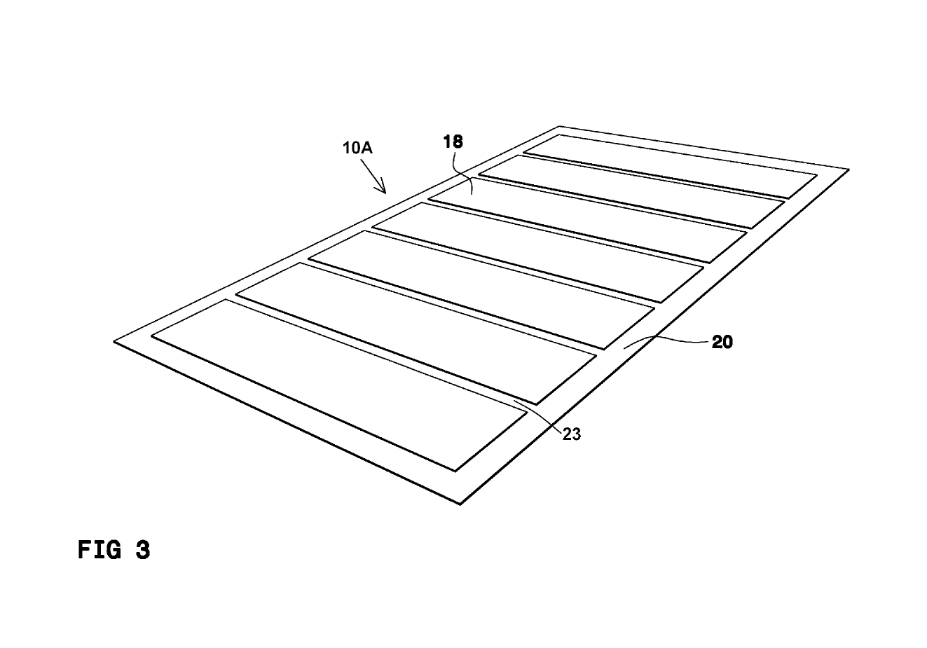

FIG. 3 depicts a single protective sheet of FIG. 2.

The protective sheet (10A) includes two layers:
1. A bottom elongated base layer (20) made of flexible material, such as polyethylene foam. This layer is flexible and impervious.
2. A plurality of rigid plates (18), such as Medium Density Fiberboard (MDF) plates stuck to the base layer (20) having gaps (23) between each rigid plate (18), in order to allow folding/rolling on termination of use.

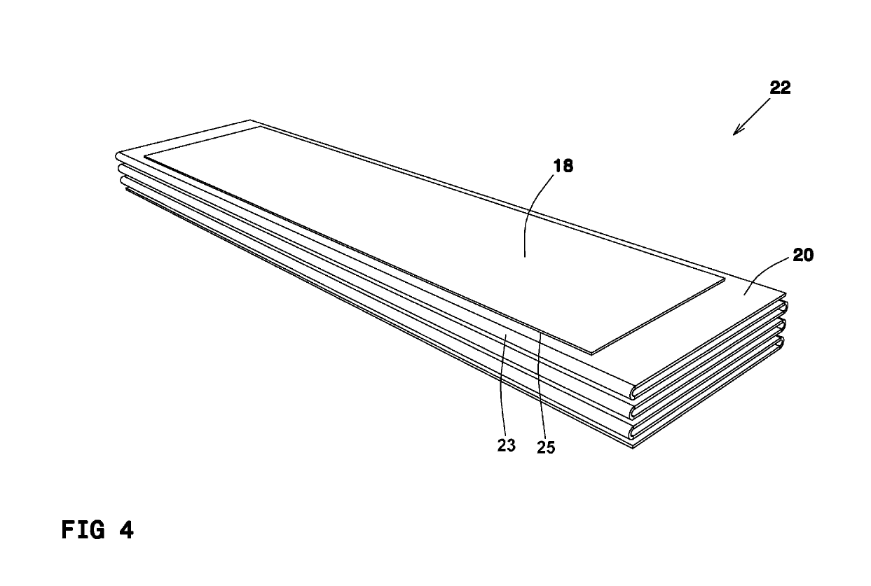

FIG. 4 shows in perspective the protective sheet of FIG. 3 in a folded state.

A consistent gap (23) between each two rigid plates (18) allows folding each base surface (20) separately, such that the rigid plates (18) are disposed one on top of the other.

In the folded state (22), the rigid plates (18) are folded one on top of the other. The ends (25) of the rigid plates (18) stuck to the flexible base surface (20) function as folding axes (25) of the base surface (20).

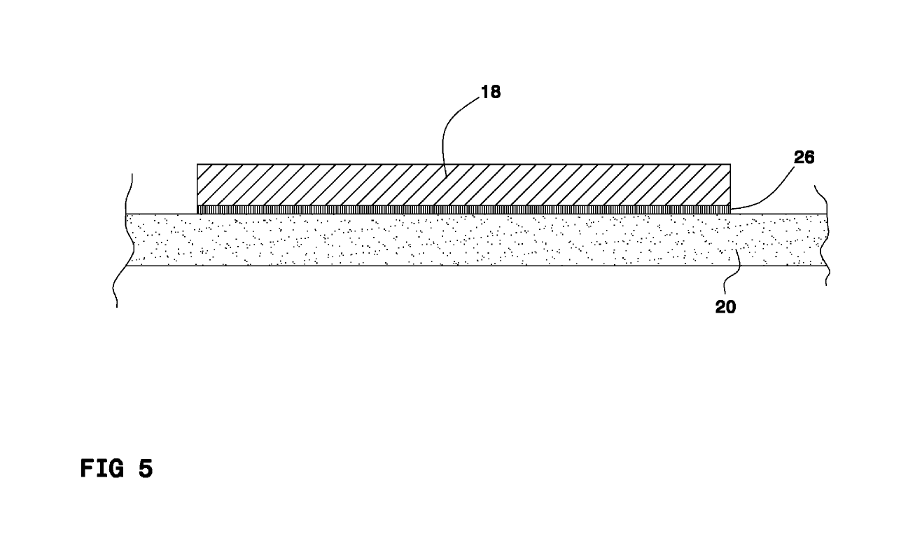

FIG. 5 shows a cross-section of the protective sheet of FIG. 3.

The bottom layer includes the flexible base surface (20). On top of it, there is a layer of glue (26), and on top of this the rigid plate (18) is placed. The flexible surface (20) is larger than the rigid plate (18).

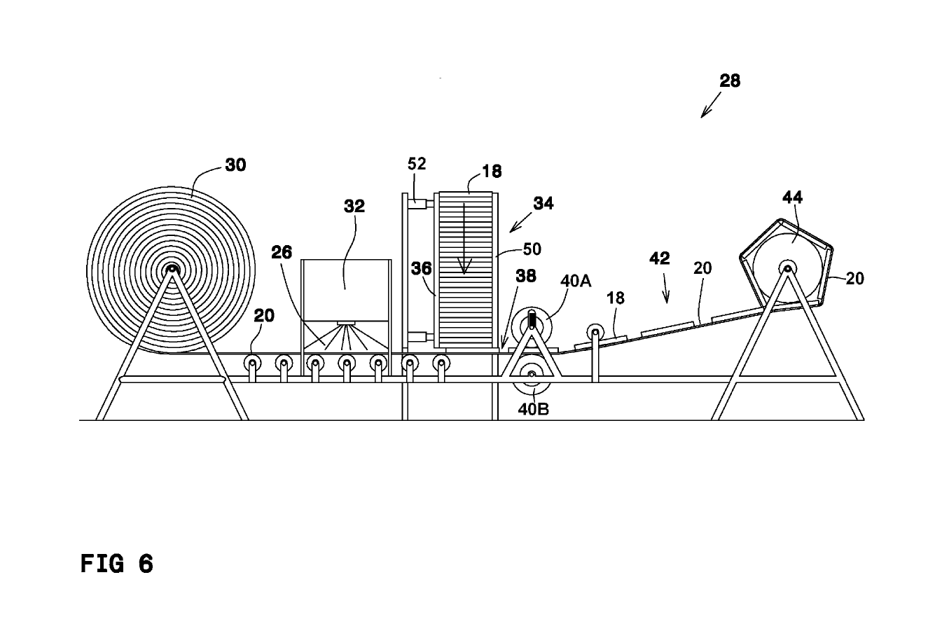

FIG. 6 is a side view showing a machine for producing the protective sheet of FIG. 3, according to one embodiment.

The manufacturing of the protective sheets is carried out using an automated machine (28).

The first station (depicted left) includes a round roller (30) on which flexible continuous sheet (20) is rolled, being later the flexible protective surface (20). The end station (depicted right) includes the product being the sheet (20) onto which rigid plates (18) are attached. The sheet (20) is rolled at the end station into a polygon roller (44) storing rigid plates (18) in a rolled form.

At the first station, the round roller (30) is rotated for supplying the flexible continuous sheet (20) along wheels (20). At the second station, a sprayer (32) sprays the flexible continuous sheet (20) with glue (26).

The third station includes a pile of the rigid plates (18). A stationary side wall (50), having an opening at the bottom being slightly larger than the thickness of one rigid plate (18), allows one rigid plate (18) at a time to be released downwards from the plate stockpile (34) in which the plates (18) are arranged one on the other.

According to another embodiment, the glue (26) may be sprayed on the rigid plates (18) instead. According to this embodiment, the order may be replaced to first spraying the glue (26) on the rigid plates (18), and then adhesion to the flexible sheet (20).

Thus, the opening at the bottom of the plate stockpile (38) allows only one rigid plate (18) at a time to descend on the area on which glue was sprayed (26). After one plate (18) descends and while it is dragged by the sheet (20), a wall (36) of the plate stockpile (34) presses a movable wall (36) by electric pistons (52), and does not allow additional plates (18) to fall.

At the fourth station, being a pressing station, two rollers, namely a first roller (40A) disposed above the sheet (20) and the rigid plate (18) and a second roller (40B) disposed below the sheet (20) press and strengthen the adhesion of the rigid plates (18) to the flexible sheet (20).

At the fifth station (42), being a storing station, the protective sheet (10A) including the rigid plates (18) is ready for use and is rolled onto the polygon drum (44). According to another embodiment, the protective sheet (10A) is folded such that the rigid plates (18) are placed one on top of the other, as depicted in FIG. 4.

The spraying (32) and the supply of the rigid plates (18) one at a time is repeated and carried out at constant intervals.

The protective sheet (10A) of the present invention may be used for curing concrete surfaces. The following describes prior art techniques regarding concrete curing.

Curing of concrete is a procedure for improving strength and hardness thereto. This happens after the concrete has been placed. Cement requires a moist, controlled environment to gain strength and harden fully. The cement paste hardens over time, initially setting and becoming rigid, though very weak and gaining in strength in the weeks following. In around 4 weeks, typically over 90% of the final strength is reached.

Hydration and hardening of concrete during the first three days is critical. Abnormally fast drying and shrinkage due to factors such as evaporation from wind during placement may lead to increased tensile stresses at a time when it has not yet gained sufficient strength, resulting in greater shrinkage and cracking. The early strength of the concrete can be increased if it is kept damp during the curing process. Minimizing stress prior to curing minimizes cracking.

Common curing methods include wet burlap and/or plastic sheeting covering the fresh concrete, or by spraying on a water-impermeable temporary curing membrane.

When concrete floors are cast in factories or warehouses, during hardening, anti-erosion materials, cement and pigments are added. These materials are introduced into the concrete by smoothing with a mechanical rotating trowel, called “helicopter”. This procedure produces a very smooth floor with the required coloring through the pigment.

These floors especially do not absorb water from the environment due to their sealing characteristic, and there is a problem of performing the concrete curing. Usually the area of these floors is “very large”, and it is impossible to dampen them continuously with a water source, since this requires a “tremendous” amount of water and a “great deal” of time.

Usually water is sprayed on the concrete surface, which is then covered with a sealing sheet, and then the water is not absorbed into the concrete and does not evaporate; thus, the water will remain between the sheet and the concrete and will serve for curing of the concrete.

Since both flexible base surface (20) and the rigid surfaces (18) of the protective sheets (10A) are impervious, they can serve as sheets for curing smoothed concrete or concrete. After spraying water on the floor at the end of the smoothing work with a mechanical tool, the concrete floor will be covered with these protective sheets (10A). The connection between the different protective sheets (10A, 10B, 10C) may be sealed by glue or welding.

The water confined between the concrete surface and the non-absorbent protective sheet (10A) may serve as a source of dampness for curing the concrete. Since the protective sheet (10A) includes rigid surfaces (18), it allows working on the concrete surface since protective sheet (10A) protects the concrete surface.

Thus, protective sheet (10A) provides both a mechanical flat working surface, and dampness for curing the concrete.

The protective sheet (10A) is intended for placing on finished surfaces (12), such as the floor surface (12). The protective sheet (10A) includes:
the flexible surface (20) constituting a base; and
two or more rigid plates (18), connected to the base surface (20) parallel to each other, so that between every two rigid plates (18) there is a space allowing folding the base surface (20).
   As a result, the protective sheet (10A) can be stored compactly until use, and can be reutilized.

The flexible base (20) may be made of polyethylene foam, or nylon with air bubbles, or another spongy material. It may include one layer or several layers; each layer may be made of a different material.

The flexible base surface (20) preferably is impervious to liquids, and hence liquids do not seep onto the finished surface (12).

The extent of the rigidity of the rigid plates (18) preferably does not allow the weight of a person treading theron to fold or deform the rigid plate (18). As well, the size of each rigid plate (18) is relatively large, as depicted in the figures. The rigidity and the size of the rigid plates (18) do not allow the weight of a person treading thereon to fold or deform the finished surface (12).

The rigid plates (18) may be made of wood, or plastic, or cardboard, Medium Density Fiberboard (MDF), etc.

The rigid plates (18) are connected to the flexible surface (20) by adhesion, or soldering, or sewing, or by studs, or by hot welding, etc.

The protective sheet (10A) may be adapted to allow folding thereof in a bellows form (like an accordion), thus allowing compact storage thereof.

The protective sheet (10A) may be adapted to allow folding thereof to a roll, thus allowing compact storage thereof.

The materials from which the protective sheet (10A) is made, including both the flexible surface (20) and the rigid plates (18) allow reducing its size by cutting. According to another embodiment, folding to the desired size is available.

According to a preferred embodiment, the flexible base (20) may be made of polyethylene foam, while the rigid plates (18) will be made of MDF.

The protective sheet (10A) may be produced manually or by an automated machine (28) which connects the flexible base (20) to the rigid plates (18), and folds or rolls it.

1. A floor surface (12) protective sheet (10A), comprising:
an elongated flexible surface (20); and
a plurality of rigid plates (18) attached to said elongated flexible surface (20),
wherein said rigid plates (18) and the attachment thereof are characterized for avoiding deformation of said elongated flexible surface (20) upon weight of a person treading thereon, thereby avoiding deformation of the floor surface (12) on which said protective sheet (10) is laid, and allowing folding said protective sheet (10A).

2. A protective sheet (10A) according to claim 1, wherein a material of said elongated flexible surface (20) comprises a member selected from a group including: polyethylene foam, nylon comprising air bubbles, another spongy material.

3. A protective sheet (10A) according to claim 1, wherein a material of said elongated flexible surface (20) is substantially impervious to liquids,
thereby adapting for curing concrete.

4. A protective sheet (10A) according to claim 1, wherein a material of said rigid plates (18) comprises a member selected from a group including: wood, plastic, cardboard, Medium Density Fiberboard (MDF).

5. A protective sheet (10A) according to claim 1, wherein the attaching of said plurality of rigid plates (18) to said elongated flexible surface (20) comprises a glue layer (26) between each rigid plate (18) and said elongated flexible surface (20).

6. A protective sheet (10A) according to claim 1, wherein the attaching of said plurality of rigid plates (18) to said elongated flexible surface (20) comprises a member selected from a group including: adhesion, soldering, sewing, studs, hot welding.

7. A protective sheet (10A) according to claim 1, wherein the attachment of said plurality of rigid plates (18) to said elongated flexible surface (20) comprises relatively small gaps (23) between each two rigid plates (18), for allowing folding said base surface (20).

8. A protective sheet (10A) according to claim 7, wherein said folding comprises disposition of said rigid plates (18) one on top of the other.

9. A protective sheet (10A) according to claim 1, further comprising one or more additional protective sheets (10B, 10C) according to claim 1, attached thereto.

10. A protective sheet (10A) according to claim 9, wherein the attaching of said one or more additional protective sheets (10B, 10C) to said protective sheet of claim 1 is sealed, thereby adapting for curing concrete.

11. A protective sheet (10A) according to claim 1, wherein the characterizing of said rigid plates (18) for avoiding deformation of said elongated flexible surface (20) upon weight of a person treading thereon comprises members selected from a group including: sufficient strength, sufficient size.

12. A machine (28) for producing a protective sheet (10A) of claim 1, said machine (28) comprising:
a roller (30) on which a flexible continuous sheet (20) is rolled;
a sprayer (32), for spraying glue (26) on said flexible continuous sheet (20); and
a pile (34) of rigid plates (18), for releasing a bottom rigid plate (18) one at a time on said sprayed glue (26);
a pressing station (40A, 40B), for pressing the rigid plates (18) onto said flexible continuous sheet (20); and
a storing station (42), for storing said flexible continuous sheet (20) pressed to said rigid plates (18).

13. A floor surface (12) protective sheet (10A), comprising:
an elongated flexible surface (20), for being laid on a floor surface (12); and
a plurality of rigid plates (18) attached, as manufactured, to said elongated flexible surface (20), the attaching comprising gaps (23) between said rigid plates (18), the gaps (23) being sufficiently large for allowing folding two adjacent rigid plates (18) one on the other, and being sufficiently small in that two adjacent rigid plates (18) substantially form a mechanical flat surface,
wherein rigidity of each of said plurality of rigid plates (18) is
sufficient for avoiding deformation of said elongated flexible surface (20) upon presence of a weight of a person treading thereon, and
wherein rigidity and thickness of each of said plurality of rigid plates (18) are limited, to allow cutting and folding thereof while laying said protective sheet (10A) on the floor surface (12), and wherein said plurality of rigid plates (18) are sufficiently thin for allowing connecting (21) an additional protective sheet (10B) to said protective sheet (10A) while maintaining said surface substantially flat,
thereby allowing producing, from a plurality of foldable sheets (10A, 10B) while laying thereof on the floor surface (12), a tailored flat surface, being a working surface, characterized of protecting the floor surface (12),
and thereby allowing storage and reutilization of said plurality of foldable sheets (10A, 10B) upon termination of use.

14. A protective sheet (10A) according to claim 13, wherein
said allowed connection (21) of said additional protective sheet (10B) to said protective sheet (10A) and
a material of said elongated flexible surface (20)
are substantially impervious to liquids,
thereby said tailored working surface is characterized of being impervious to liquids.

15. A floor surface (12) protective sheet (10A) according to claim 13, wherein said elongated flexible surface (20), being disposed between said floor surface (12) and said rigid plates (18) is soft,
thereby absorbing physical changes between said floor surface (12), being typically rigid, and said rigid plates (18).
